(19) United States
(12) Patent Application Publication
(10) Pub. No.: US 2023/0411634 A1
(43) Pub. Date: Dec. 21, 2023

(54) Metal Air Battery and Manufacturing Method of Air Electrode

(71) Applicant: Nippon Telegraph and Telephone Corporation, Tokyo (JP)

(72) Inventors: Mikayo Iwata, Musashino-shi, Tokyo (JP); Masaya Nohara, Musashino-shi, Tokyo (JP); Hiroaki Taguchi, Musashino-shi, Tokyo (JP); Takeshi Komatsu, Musashino-shi, Tokyo (JP)

(21) Appl. No.: 18/249,140

(22) PCT Filed: Nov. 4, 2020
(86) PCT No.: PCT/JP2020/041210

§ 371 Date: Apr. 14, 2023

(51) Int. Cl. H01M 4/90; H01M 12/06; H01M 4/88

(52) U.S. Cl. CPC H01M 4/9016; H01M 12/06; H01M 4/8842

(57) ABSTRACT

A metal-air battery includes: an air electrode; a negative electrode containing a metal; and an electrolyte having ion conductivity. The air electrode includes: a co-continuous body having a three-dimensional network structure in which a plurality of nanostructures is split and integrated; and mesoporous carbon supported on the co-continuous body.

### TECHNICAL FIELD

The present invention relates to a metal-air battery and a method for manufacturing an air electrode.

### BACKGROUND ART

Metal-air batteries have been researched and developed as possible batteries with low environmental burdens these days. In metal-air batteries, oxygen and water are used as positive-electrode active materials, and a metal such as magnesium, iron, aluminum, or zinc is used for the negative electrode. Accordingly, the influence on soil contamination and the like, and the influence on ecosystems are also small. Furthermore, these are materials with abundant resources, and are less expensive than rare metals.

Particularly, zinc-air batteries using zinc for the negative electrode have been commercialized as the drive sources for hearing aids and the like. Also, magnesium-air batteries using magnesium for the negative electrode have been researched and developed as batteries with low environmental burdens (see Non Patent Literature 1 and Non Patent Literature 2).

### CITATION LIST

### Non Patent Literature

Non Patent Literature 1: Y. Xue, and two others, “Template-directed fabrication of porous gas diffusion layer for magnesium air batteries”, Journal of Power Sources, vol. 297, pp. 202-207, 2015
Non Patent Literature 2: N. Wang, and five others, “Discharge behavior of Mg—Al—Pb and Mg—Al—Pb—In alloys as anodes for Mg-air battery”, Electrochimica Acta, vol. 149, pp. 193-205, 2014

### SUMMARY OF INVENTION

### Technical Problem

However, in Non Patent Literature 1, a fluororesin is used as a binder in an air electrode. In Non Patent Literature 2, a metal containing lead or indium is used for the negative electrode, and materials that might adversely affect the natural environments, such as soil contamination, are involved.

On the other hand, a metal-air battery formed with a material taking natural environments into consideration can eliminate environmental problems by not using any environmentally hazardous substance such as a rare metal. However, when a metal-air battery is manufactured without the use of a rare metal or the like, the battery performance is degraded.

The present invention has been made in view of this problem, and aims to improve the performance of a metal-air battery.

### Solution to Problem

A mode of the present invention is a metal-air battery that includes: an air electrode; a negative electrode containing a metal; and an electrolyte having ion conductivity. The air electrode includes: a co-continuous body having a three-dimensional network structure in which a plurality of nanostructures is split and integrated; and mesoporous carbon supported on the co-continuous body.

A mode of the present invention is a method for manufacturing an air electrode of a metal-air battery. The method for manufacturing an air electrode of a metal-air battery includes: a synthesizing step of synthesizing mesoporous carbon; a producing step of producing a sol or gel in which the mesoporous carbon and a plurality of nanostructures are dispersed; a freezing step of freezing the sol or gel, to obtain a frozen material; and a drying step of drying the frozen material in vacuum, to obtain a co-continuous body having a three-dimensional network structure, the mesoporous carbon being supported on the co-continuous body, the plurality of nanostructures being split and integrated in the co-continuous body.

A mode of the present invention is a method for manufacturing an air electrode of a metal-air battery. The method includes: a precursor synthesizing step of causing mesoporous silica as a template to react with an organic compound, to obtain a precursor of mesoporous carbon; a producing step of producing a sol or gel in which the precursor and a plurality of nanostructures are dispersed; a freezing step of freezing the sol or gel, to obtain a frozen material; a drying step of drying the frozen material in vacuum, to obtain a co-continuous body having a three-dimensional network structure, the precursor being supported on the co-continuous body, the plurality of nanostructures being split and integrated in the co-continuous body; a carbonizing step of heating the co-continuous body in an inert gas atmosphere, to carbonize the precursor supported on the co-continuous body; and a synthesizing step of performing etching on the carbonized precursor, to remove the mesoporous silica of the precursor, and synthesizing the mesoporous carbon.

### Advantageous Effects of Invention

According to the present invention, the performance of a metal-air battery with a low environmental burden can be improved.

### BRIEF DESCRIPTION OF DRAWINGS

FIG. 1 is a configuration diagram illustrating the configuration of a metal-air battery according to an embodiment of the present invention.

FIG. 2 is a flowchart of Manufacturing Method 1.

FIG. 3 is a flowchart of Manufacturing Method 2.

FIG. 4 is a flowchart of Manufacturing Method 3.

FIG. 5 is a flowchart of Manufacturing Methods 4, 5, and 6.

FIG. 6A is an external view of a coin-cell zinc-air battery of Example 1.

FIG. 6B is a bottom view of the coin-cell zinc-air battery of Example 1.

FIG. 7 is a graph showing a discharge curve in Example 1.

### DESCRIPTION OF EMBODIMENTS

The following is a description of embodiments of the present invention, with reference to the drawings.

### Configuration of a Metal-Air Battery

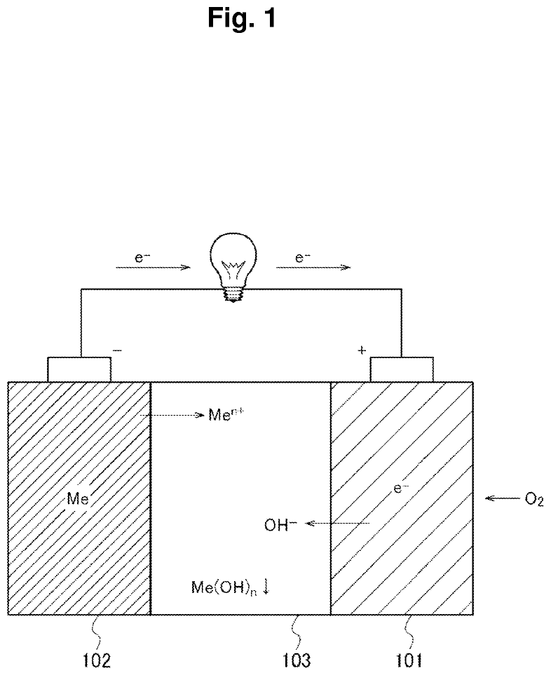

FIG. 1 is a configuration diagram illustrating the configuration of a metal-air battery according to an embodiment of the present invention. A metal-air battery uses air (oxygen) and water as positive-electrode active materials, and a metal as a negative-electrode active material. The metal-air battery illustrated in the drawing includes a gas diffusion air electrode 101 that is a positive electrode, a negative electrode 102 containing metal, and an electrolyte 103 interposed between the air electrode 101 and the negative electrode 102.

One surface of the air electrode 101 is exposed to the atmosphere, and the other surface is in contact with the electrolyte 103. The air electrode 101 contains a conductive material. The air electrode 101 may contain a catalyst. The surface of the negative electrode 102 on the side of the electrolyte 103 is in contact with the electrolyte 103. The negative electrode 102 contains metal. The electrolyte 103 has ion conductivity, and may be either an electrolytic solution or a solid electrolyte. An electrolytic solution refers to an electrolyte in a liquid form. Meanwhile, a solid electrolyte refers to an electrolyte in a gel form or a solid form. In the description below, each of the above components is explained.

(I) Air Electrode (Positive Electrode)

In this embodiment, the air electrode 101 contains a conductive material and a catalyst. The conductive material contains a co-continuous body and mesoporous carbon supported on the co-continuous body. Mesoporous carbon is carbon having uniform fine pores.

(I-1) Conductive Material (Co-Continuous Body)

The co-continuous body of the conductive material of the air electrode 101 is now described. The co-continuous body is a material having a three-dimensional network structure in which a plurality of nanostructures is split and integrated. The co-continuous body is a porous body, and has an integral structure. The nanostructures may be nanosheets, nanofibers, or the like, for example. In the co-continuous body, a plurality of nanostructures that are integrated has branches to form a three-dimensional network structure. Accordingly, the co-continuous body has a structure in which the branch portions between the nanostructures are deformable and stretchable.

The nanosheets may be formed with at least one kind of material selected from the group consisting of carbon, iron oxides, manganese oxides, magnesium oxides, molybdenum oxides, and molybdenum sulfide compounds, for example. Examples of the molybdenum sulfide compounds include molybdenum disulfides and phosphorus-doped molybdenum sulfides. An element of these materials may be any appropriate element that contains at least one of the 16 elements (C, O, H, N, P, K, S, Ca, Mg, Fe, Mn, B, Zn, Cu, Mo, and Cl) essential for the growth of plants.

It is important that the nanosheets have conductivity. A nanosheet is defined as a sheet-like substance that has a thickness of 1 nm to 1 μm, and a planar longitudinal/lateral length 100 or more times greater than the thickness. Examples of carbon nanosheets include graphene. Alternatively, the nanosheets may have a roll-like shape or a wave-like shape, or the nanosheets may be curved or bent, having any appropriate shape.

The nanofibers may contain at least one kind of material selected from the group consisting of carbon, iron oxides, manganese oxides, magnesium oxides, molybdenum oxides, molybdenum sulfides, and cellulose (carbonized cellulose). Alternatively, the nanofibers may be formed with at least one kind of material selected from the above group. An element of these materials may be any appropriate element that contains at least one of the 16 elements (C, O, H, N, P, K, S, Ca, Mg, Fe, Mn, B, Zn, Cu, Mo, and Cl) essential for the growth of plants.

It is important that the nanofibers also have conductivity. A nanofiber is defined as a fibrous substance that has a diameter of 1 nm to 1 μm, and a length 100 or more times greater than the diameter. Also, a nanofiber may have a hollow shape, a coil-like shape, or any other appropriate shape. Note that the cellulose to be used is carbonized to have conductivity as described later.

(I-2) Conductive Material (Mesoporous Carbon)

Next, of the conductive material of the air electrode 101, the mesoporous carbon supported on the co-continuous body is described. The mesoporous carbon is obtained by modifying the surface of mesoporous silica with an organic compound, and carbonizing the modified mesoporous silica.

The mesoporous silica can be produced by a known production method, and is not limited to any particular kind as long as it can be coated with carbon. The mesoporous silica may be formed with any of the SBA series using a block copolymer (SBA-15, SBA-16, SBA-1, SBA-3, and SBA-12), any of the MCM series using a small-molecule cationic surfactant (MCM-41, MCM-48, and MCM-50), FMS-16, KIT-5, KIT-6, MSU-1, MSU-3, HMS, or the like, for example.

Alternatively, the mesoporous carbon may be synthesized without the use of mesoporous silica. Specific examples include STARBON series and the like.

The organic compound can be produced by a known process in which mesoporous silica is organically modified and is carbonized to be coated with carbon.

Using the (I-1) conductive material (co-continuous body) and the (I-2) conductive material (mesoporous carbon) described above, it is possible to manufacture the air electrode.

For example, first, mesoporous carbon is synthesized by a known manufacturing process. The mesoporous carbon is mixed with a sol or gel in which nanostructures are dispersed, and the mixture is frozen to obtain a frozen material (the freezing step). By drying the frozen material in vacuum (the drying step), it is possible to manufacture a co-continuous body on which the conductive material to be the air electrode 101, which is the mesoporous carbon, is supported.

A gel in which nanofibers formed with an iron oxide, a manganese oxide, silicon, or cellulose are dispersed can be created by predetermined bacteria (the gel producing step). Alternatively, a gel in which nanofibers formed with cellulose are dispersed may be produced by predetermined bacteria (the gel producing step), and this gel may be carbonized by heating in an inert gas atmosphere so that the co-continuous body is obtained (the carbonizing step).

The co-continuous body forming the air electrode 101 (conductive material) preferably has an average pore size of 0.1 to 50 μm, or more preferably 0.1 to 2 μm, for example. Here, the average pore size is a value measured by a mercury intrusion technique.

For the air electrode 101, it is not necessary to use an additional material such as a binder as in a case where powdered carbon is used. This is advantageous in terms of cost and environmental aspects.

Electrode reactions in the air electrode 101 and the negative electrode 102 are now described. In an air electrode reaction, the oxygen in the air and the electrolyte come into contact with each other on the surface of the air electrode 101 having conductivity, so that a reaction expressed by “1/2O₂+H₂O+2e⁻→2OH⁻ . . . (1)” proceeds. On the other hand, in a negative electrode reaction, a reaction expressed by “Me→Meⁿ⁺+ne⁻ . . . (2) (Me represents the metal, and n represents the valence of the metal)” proceeds in the negative electrode 102 in contact with the electrolyte 103, and the metal forming the negative electrode 102 emits electrons and is dissolved as n-valent metal ions in the electrolyte 103.

Through these reactions, electric discharge can be performed. The entire reaction is expressed as “Me+1/2O₂+H₂O→Me(OH)ₙ . . . (3)”, and is a reaction in which a hydroxide is generated (precipitated). The compounds involved in the above reactions are shown with the components in FIG. 1.

As described above, in the metal-air battery, the reaction expressed by Expression (1) proceeds on the surface of the air electrode 101, and therefore, it is considered better to generate a large number of reaction sites inside the air electrode 101.

The air electrode 101, which is a positive electrode, can be manufactured by a known process such as a process of molding powdered carbon with a binder. However, it is important to generate a large number of reaction sites inside the air electrode 101 in the metal-air battery as described above, and the air electrode 101 preferably has a high specific surface area. For example, in this embodiment, the specific surface area of the co-continuous body forming the air electrode 101 is preferably not smaller than 200 m²/g %, or more preferably, not smaller than 300 m²/g.

In the case of a conventional air electrode that is prepared by molding powdered carbon with a binder and pelletizing the powdered carbon, when the specific surface area is increased, the binding strength between the carbon particles becomes lower, and the structure is degraded. Therefore, it becomes difficult to perform stable electric discharge, and the voltage drops.

On the other hand, the air electrode 101 of this embodiment includes the co-continuous body having a three-dimensional network structure in which a plurality of nanostructures is integrated by non-covalent binding. Thus, the above-described problem can be solved, and the voltage can be made higher. Further, as the air electrode 101 of this embodiment contains mesoporous carbon, not only the specific surface area increases, but also the oxygen adsorption capacity increases. Accordingly, the oxygen reduction reaction (electric discharge) at the air electrode 101 is facilitated, and thus, the battery performance is greatly improved.

(I-3) Catalyst

The catalyst contains at least one metal selected from the group consisting of iron, manganese, zinc, copper, and molybdenum, or an oxide (a metal oxide) of at least one metal selected from the group consisting of calcium, iron, manganese, zinc, copper, and molybdenum.

Note that any of the elements of these materials is formed with a metal contained in the 16 essential elements essential for the growth of plants, and is only required to have catalytic capacity. The metal is preferably iron, manganese, or zinc, and the oxide is preferably an oxide of one metal selected from these metals or a composite oxide of at least two of these metals. Particularly, manganese oxide (MnO₂) is preferable. Manganese oxide is preferable because it exhibits particularly excellent catalytic performance in this embodiment.

Also, the metal oxide as the catalyst is preferably an amorphous metal oxide as a hydrate. For example, a hydrate of the transition metal oxide described above may be used. More specifically, a (IV)-n hydrate of manganese oxide may be used. Note that n represents the number of moles of H₂O with respect to 1 mol of MnO₂. As a hydrate of manganese oxide is highly dispersed as nano-sized fine particles on the surface of the co-continuous body forming the air electrode 101, excellent battery performance can be achieved.

For example, when a manganese oxide hydrate (MnO₂·nH₂O) highly dispersed and deposited (added) as nano-sized fine particles on the conductive material of the air electrode 101 is used as the air electrode 101, excellent battery performance can be achieved. The content of the catalyst contained in the air electrode 101 is to 70 wt %, or preferably, 1 to 30 wt %, on the basis of the total weight of the air electrode 101.

As a transition metal oxide is added as the catalyst to the air electrode 101, battery performance is greatly improved. The air electrode 101 and the electrolyte 103 are in contact with each other, and at the same time, an oxygen gas in the atmosphere is supplied, to form a three-phase interface of an electrolyte, an electrode, and a gas (oxygen). When the catalyst is highly active at this three-phase interface site, oxygen reduction (electric discharge) on the electrode surface smoothly proceeds, and battery performance is greatly improved. At this point of time, the catalyst has a strong interaction with oxygen as a positive-electrode active material. Therefore, the catalyst can adsorb many oxygen species onto its surface or occlude oxygen species in oxygen vacancies.

As described above, the oxygen species adsorbed onto the surface of the metal oxide forming the catalyst or occluded in the oxygen vacancies are used as the oxygen source (active intermediate reactant) of the above Expression (1) in an oxygen reduction reaction, so that the above reaction easily proceeds. The material that effectively functions as the catalyst may be a metal oxide such as manganese oxide, as mentioned above. Other than metal oxides, a metal can be used as the catalyst, and a metal also functions in the same manner as a metal oxide.

In the metal-air battery, to increase battery efficiency, there preferably exist a larger number of reaction sites (three-phase portions of an electrolyte, an electrode, and the air (oxygen)) that cause an electrode reaction, as described above. From such a viewpoint, it is important that a large number of the above-described three-phase sites is also present on the surface of the catalyst, and the catalyst preferably has a high specific surface area. The specific surface area of the catalyst formed with a metal or a metal oxide may be 0.1 to 1000 m²/g, or preferably 1 to 500 m²/g. Note that the specific surface area is a specific surface area determined by a known BET method involving N2 adsorption.

The air electrode 101 to which the catalyst is added can be manufactured by the method for manufacturing the air electrode 101 described later.

(II) Negative Electrode

Next, the negative electrode 102 is described. The negative electrode 102 contains a negative-electrode active material. This negative-electrode active material is not limited to any specific material, as long as it is a material that can be used as the negative electrode material of a metal-air battery, or is a material selected from the group consisting of magnesium, aluminum, calcium, iron, and zinc, or a material containing, as a principal component, a material selected from the group. For example, the negative electrode 102 may be formed with a metal serving as a negative electrode, a sheet of metal, or a material obtained by pressure-bonding powder to metal foil such as copper foil.

The negative electrode 102 can be formed by a known technique. For example, in a case where a magnesium metal is used as the negative electrode 102, it is possible to create the negative electrode 102 by forming a plurality of sheets of metallic magnesium foil in a predetermined shape in an overlapping manner.

(III) Electrolyte

The electrolyte 103 of the metal-air battery is only required to be a material capable of transferring metal ions and hydroxide ions between the air electrode 101 (the positive electrode) and the negative electrode 102. For example, the material may be a metal salt containing potassium, sodium, or the like abundantly present on the earth. Note that the metal salt is only required to be formed with any of the 16 elements (C, O, H, N, P, K, S, Ca, Mg, Fe, Mn, B, Zn, Cu, Mo, and Cl) essential for the growth of plants, ant element contained in seawater or rainwater, or the like.

The electrolyte 103 is only required to be formed with acetate acid, carbonic acid, citric acid, malic acid, oxalic acid, phosphoric acid, or a salt of any of those materials, HEPES (4-(2-hydroxyethyl)-1-piperazineethanesulfonic acid), pyrophosphate, metaphosphate, or the like, for example. Citric acid, malic acid, and oxalic acid are used as fertilizers, and have a function of facilitating phosphorus absorption into plants by forming complexes with phosphorus, which is one of the macro-elements among the fertilizer components. Therefore, if the electrolyte leaks into the soil, the electrolyte does not adversely affect the soil, but functions as a fertilizer. For this reason, citric acid, malic acid, oxalic acid, or a salt thereof is particularly preferable for the electrolyte 103.

Further, an aromatic anion-exchange polymer solid electrolyte having ion conductivity for passing metal ions and hydroxide ions, an inorganic layered compound-based solid electrolyte, or the like may be used as another material forming the electrolyte 103.

(IV) Other Components

In addition to the above components, the metal-air battery of this embodiment can include structural members such as a separator, a battery case, and a metallic mesh (a titanium mesh, for example), and any other components required for the metal-air battery. Conventional components can be used for these components. The separator is not limited to any specific one as long as the separator is formed with a fiber material, but a cellulose-based separator formed with plant fibers or bacteria is preferable.

Next, a method for manufacturing the metal-air battery is described. It is possible to manufacture the metal-air battery of this embodiment by appropriately disposing the air electrode 101 obtained by the air electrode manufacturing method described later, the negative electrode 102, and the electrolyte 103, together with other necessary components based on the desired metal-air battery structure, in a suitable container such as a case. In the procedures for manufacturing such a metal-air battery, conventionally known methods can be used.

In the description below, manufacturing of the air electrode 101 is described.

(V-1) Method for Manufacturing the Conductive Material to be Used for the Air Electrode

Manufacturing Method 1

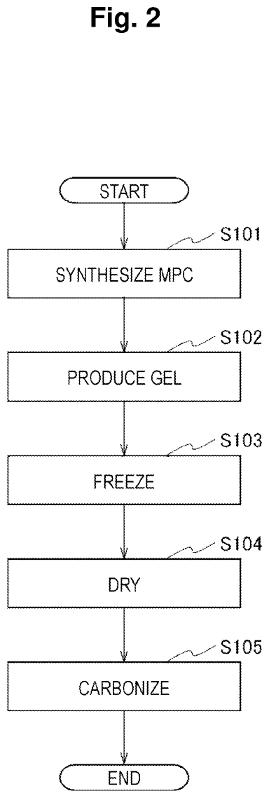

First, Manufacturing Method 1 is described with reference to FIG. 2. FIG. 2 is a flowchart for explaining Manufacturing Method 1.

First, in step S101, mesoporous carbon (hereinafter referred to as MPC) is synthesized, using mesoporous silica as the precursor.

Commercially available mesoporous silica can be used. Examples thereof include SBA-15 (manufactured by Sigma-Aldrich Co. LLC), MCM-41 (manufactured by Sigma-Aldrich Co. LLC), and HMS (manufactured by Sigma-Aldrich Co. LLC). Also, other known production methods can be used, and it is possible to use FMS-16, KIT-5, MSU-1, MSU-3, HMS, and the like, in addition to the SBA series using a block copolymer (SBA-15, SBA-16, SBA-1, SBA-3, and SBA-12), the MCM series using a small-molecule cationic surfactant (MCM-41, MCM-48, and MCM-50).

A known production method can be used for the synthesis of MPC. For example, silanol groups on the surface of a silica material are silylated using an organic silylating agent, and the organic groups are eliminated by a heat treatment to generate Si radicals on the surface of the silica material. Thus, carbon coating can be performed by the CVD method. Examples of the carbon source to be used in the CVD method include alcohols having hydroxyl groups such as methanol, ethanol, propanol, and butanol, carboxylic acid groups such as pyrrolidone anhydride, thiophene, pyridine, acrylonitrile, and acetonitrile, and organic compounds containing nitrogen, sulfur, or the like.

Also, as another method for producing MPC, it is possible to adopt MPC obtained by filling mesoporous silica with sucrose and sulfuric acid, and then removing the silica template through burning under vacuum and alkali etching. Also, the STARBON series, which is MPC obtained by gelatinizing starch in water followed by drying and heating, may be used without the use of mesoporous silica.

Next, in step S102, a sol or gel in which the obtained MPC and a plurality of nanostructures are dispersed is prepared. Specifically, the MPC obtained in step S101 is dispersed in a sol or gel in which a plurality of nanostructures such as nanosheets and nanofibers is dispersed (the gel producing step). The sol or gel prepared herein is the precursor of the co-continuous body supporting the MPC. A dispersion medium is added to the MPC as a dispersoid and the nanostructures, and the mixture is stirred to obtain the sol or gel.

A sol means a colloid formed with a dispersion medium and nanostructures that are the dispersoid. Specifically, a sol means a dispersion system having a shear elastic modulus of 1 Pa or lower. A gel means a solid in which a dispersion medium has lost fluidity due to a three-dimensional network structure such as nanostructures serving as a dispersoid. Specifically, a gel means a dispersion system having a shear elastic modulus of 10² to 10⁶ Pa.

The dispersion medium of a sol or gel is an aqueous system such as water (H₂O), or an organic system such as carboxylic acid, methanol (CH₃OH), ethanol (C₂H₅OH), propanol (C₃H₇OH), n-butanol, isobutanol, n-butylamine, dodecane, unsaturated fatty acid, ethylene glycol, heptane, hexadecane, isoamyl alcohol, octanol, isopropanol, acetone, or glycerin. Two or more of these materials may be mixed as the dispersion medium.

Commercially available nanosheets and nanofibers as dispersoids can be used. For example, it is possible to use nanosheets that are formed with at least one of compounds containing, as a principal component, graphene powder (manufactured by Sigma-Aldrich Co. LLC), an iron oxide (manufactured by Kanto Chemical Co., Inc.), a manganese oxide (manufactured by Kanto Chemical Co., Inc.), a zinc oxide (manufactured by Kanto Chemical Co., Inc.), a molybdenum oxide (manufactured by Kanto Chemical Co., Inc.), silica (manufactured by Kanto Chemical Co., Inc.), a titanium oxide (manufactured by Kanto Chemical Co., Inc.), or alumina (manufactured by Kanto Chemical Co., Inc.). Alternatively, it is possible to nanofibers that contain at least one of compounds containing, as a principal component, an iron oxide (manufactured by Kanto Chemical Co., Inc.), a manganese oxide (manufactured by Kanto Chemical Co., Inc.), a zinc oxide (manufactured by Kanto Chemical Co., Inc.), a molybdenum oxide (manufactured by Kanto Chemical Co., Inc.), silica (manufactured by Kanto Chemical Co., Inc.), a titanium oxide (manufactured by Kanto Chemical Co., Inc.), alumina (manufactured by Kanto Chemical Co., Inc.), or cellulose (Nippon Paper Industries Co., Ltd.).

As a co-continuous body that is a three-dimensional network structure having a high specific surface area is formed with nanostructures such as nanofibers or nanosheets, pores play the role of a cushion during compression or tension, and have an excellent stretchability. Specifically, the co-continuous body preferably has a strain of 5% or higher at the elasticity limit, or more preferably has a strain of 10% or higher. By adjusting the concentration of the gel or sol, the specific surface area of the co-continuous body can be freely adjusted. The lower the concentration of the gel or sol, the higher the specific surface area of the resultant co-continuous body. However, if the concentration is 0.01 wt % or lower, it is difficult for the dispersoid to form a three-dimensional network structure. Therefore, the concentration of the dispersoid is preferably 0.01 to 10 wt %.

The freezing step in step S103 is a step of freezing the sol or gel to obtain a frozen material. The freezing step is carried out, for example, by storing the sol or gel having nanostructures dispersed therein into an appropriate container such as a test tube, and cooling the periphery of the container in a coolant such as liquid nitrogen. The technique for freezing is not limited to any specific technique, as long as the dispersion medium of the gel or sol can be cooled to a temperature equal to or lower than the freezing point. The dispersion medium may be cooled in a freezer or the like. As the gel or sol is frozen, the dispersion medium loses its fluidity, the dispersoid is fixed, and a three-dimensional network structure is constructed.

In a case where the dispersoid is not fixed in the freezing step, the dispersoid is aggregated as the dispersion medium evaporates in the subsequent drying step. Therefore, a sufficiently high specific surface area cannot be obtained, and it is difficult to prepare a co-continuous body having a three-dimensional network structure.

Next, in step S104, the obtained frozen material is dried in vacuum, to obtain a co-continuous body supporting MPC (the drying step). The co-continuous body is a material having a three-dimensional network structure in which a plurality of nanostructures is split and integrated. The drying step in step S104 is a step of drying the frozen material obtained in the freezing step in vacuum, to extract the dispersoid maintaining or constructing the three-dimensional network structure from the dispersion medium.

In the drying step, the frozen material obtained in the freezing step is dried in vacuum, and the frozen dispersion medium is sublimated from the solid state. For example, the frozen material is housed in an appropriate container such as a flask, and the inside of the container is vacuumed. As the frozen material is placed in a vacuum atmosphere, the sublimation point of the dispersion medium drops, and even a substance that is not sublimated at ordinary pressure can be sublimated.

The degree of vacuum in the drying step varies with the dispersion medium being used, but is not limited to any specific degree as long as the dispersion medium sublimates. For example, in a case where water is used as the dispersion medium, the degree of vacuum needs to be set so that the pressure becomes 0.06 MPa or lower. However, heat is taken away as latent heat of sublimation, and therefore, drying takes time. In view of this, the degree of vacuum is preferably 1.0×10⁻⁶ to 1.0×10⁻² Pa. Furthermore, heat may be applied from a heater or the like during the drying.

In the method of drying in the air, the dispersion medium changes from a solid to a liquid and then changes from the liquid to a gas, so that the frozen material enters a liquid state. Therefore, the dispersoid becomes fluid again in the dispersion medium, and the three-dimensional network structure of the plurality of nanostructures collapses. Because of this, it is difficult to produce a co-continuous body having stretchability by drying in the atmosphere.

The carbonizing step in step S105 is performed so that carbonization imparts conductivity in a case where the nanostructures are cellulose nanofibers. In a case where the nanostructures are not cellulose nanofibers, the carbonizing step is not necessary.

Carbonization of the co-continuous body may be performed by burning the co-continuous body at 200° C. to 2000° C., or more preferably at 600° C. to 1800° C., in an inert gas atmosphere. The gas in which cellulose nanofibers (cellulose) do not burn may be an inert gas such as a nitrogen gas or an argon gas, for example. Alternatively, the gas may be a reducing gas such as a hydrogen gas or a carbon monoxide gas, or may be a carbon dioxide gas.

The co-continuous body obtained in this manner has a high conductivity, a corrosion resistance, and a high specific surface area, and is suitable for a battery, a capacitor, a fuel cell, a biofuel cell, a microbial fuel cell, a catalyst, a solar cell, a semiconductor manufacturing process, a medical device, a cosmetic device, a filter, a heat resistant material, a flame resistant material, a heat insulating material, a conductive material, an electromagnetic wave shielding material, an electromagnetic wave noise absorbing material, a heating element, a microwave heating element, cone paper, clothes, a carpet, mirror antifogging, a sensor, a touch panel, or the like.

Manufacturing Method 2

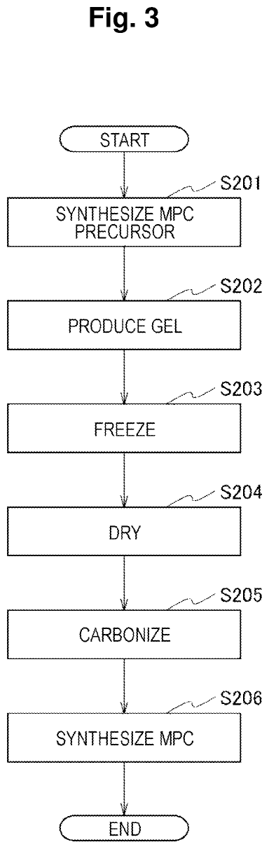

Next, Manufacturing Method 2 is described with reference to FIG. 3. FIG. 3 is a flowchart for explaining Manufacturing Method 2. By Manufacturing Method 2, the conductive material of the air electrode is produced by a method different from Manufacturing Method 1.

First, in step S201, mesoporous silica serving as a template is made to react with an organic compound, to synthesize the precursor of MPC (the MPC precursor synthesizing step). The precursor of MPC is a dispersion liquid using mesoporous silica as a template. In synthesizing the precursor, it is possible to use a production method using sucrose, starch, or the like used in a hard template method, or a production method using resorcinol, phloroglucinol, a non-ionic surfactant, a formaldehyde resin, or the like used in a soft template method, for example.

The dispersion medium for dispersing mesoporous silica and an organic compound may be carboxylic acid, methanol (CH₃OH), ethanol (C₂H₅OH), propanol (C₃H₇OH), n-butanol, isobutanol, n-butylamine, dodecane, unsaturated fatty acid, ethylene glycol, heptane, hexadecane, isoamyl alcohol, octanol, isopropanol, acetone, glycerin, or the like. However, since mesoporous silica has a low water resistance, it is preferable to use 50% to 100% of an organic solvent in the dispersion liquid. The stirring time of the dispersion liquid may be one day to seven days, or preferably one day to three days.

Next, in step S202, a sol or gel in which the obtained precursor of MPC and a plurality of nanostructures are dispersed is prepared. Specifically, the MPC precursor obtained in step S201 is dispersed in a sol or gel in which a plurality of nanostructures such as nanosheets and nanofibers is dispersed (the gel producing step). That is, a sol or gel mixed with the precursor of MPC is produced. The sol or gel produced herein is the co-continuous body precursor in which the precursor of MPC is supported on the nanostructures.

In step S203, the sol or gel prepared in step S202 is frozen, to obtain a frozen material (the freezing step). Next, in step S204, the frozen material is dried in vacuum, to obtain a co-continuous body supporting the precursor of MPC (the drying step). The manufacturing method in steps S202 to S204 may be adjusted in the same manner as steps S102 to S104 described in Manufacturing Method 1.

Next, in step S205, the prepared co-continuity is carbonized under an inert atmosphere (the carbonizing step). The carbonizing step is to remove organic substances from the precursor of MPC, and to impart conductivity to cellulose nanofibers when the cellulose nanofibers are used as the nanostructures. The co-continuous body carbonized in this manner has a high conductivity, a corrosion resistance, a high stretchability, and a high specific surface area, and is suitable as the air electrode of a metal-air battery.

The carbonization may be performed by synthesizing a co-continuous body having a three-dimensional network structure in the freezing step and the drying step described above, and then burning (heating) the co-continuous body in an inert gas atmosphere at 200° C. to 2000° C., or more preferably at 600° C. to 1800° C., to carbonize the MPC precursor supported on the co-continuous body. Thus, organic substances ire removed from the precursor of MPC.

Further, in a case where cellulose nanofibers are used as the nanostructures, not only the precursor of MPC but also the co-continuous body is carbonized by the carbonizing step. In this case, the gas in which cellulose does not burn may be an inert gas such as a nitrogen gas or an argon gas, for example. Alternatively, the gas may be a reducing gas such as a hydrogen gas or a carbon monoxide gas, or may be a carbon dioxide gas. In this embodiment, a carbon dioxide gas or a carbon monoxide gas that has an activating effect on carbon materials and can be expected to greatly activate the co-continuous body is more preferable.

Next, in step S205, etching is performed on the carbonized co-continuous body (the precursor of MPC), to remove the mesoporous silica from the precursor of MPC, and synthetize MPC. The mesoporous silica can be removed from the precursor of MPC by etching using caustic soda (NaOH), hydrofluoric acid (HF), or the like. By removing the mesoporous silica, it is possible to reduce the weight of the air electrode, and improve the weight energy density as a battery.

(V-2) Method for Manufacturing the Conductive Material that Supports a Catalyst and is to be Used for the Air Electrode

Manufacturing Method 3 (Catalyst)

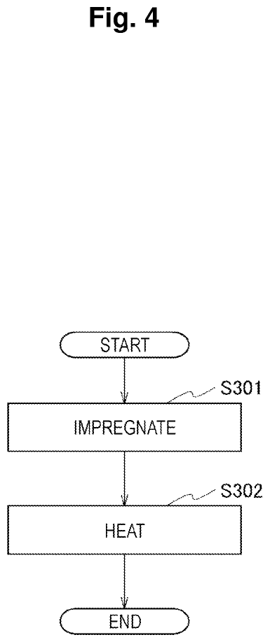

Next, Manufacturing Method 3 is described with reference to FIG. 4. FIG. 4 is a flowchart for explaining Manufacturing Method 3.

As described above, the catalyst may be supported on the air electrode. By Manufacturing Method 3, a catalyst is supported on a MPC-supporting co-continuous body manufactured by Manufacturing Method 1 or Manufacturing Method 2. Manufacturing Method 3 includes the catalyst supporting steps described below for supporting a catalyst, in addition to the co-continuous body manufacturing described above.

In step S301, a co-continuous body obtained by Manufacturing Method 1 or Manufacturing Method 2 described above is impregnated with an aqueous solution of the metal salt that is the precursor of the catalyst (the impregnating step). After the stretchable co-continuous body containing the metal salt is prepared in this manner, the stretchable co-continuous body containing the metal salt may be subjected to a heat treatment in step S302 (the heating step). Note that a preferred metal for the metal salt to be used is at least one metal selected from the group consisting of iron, manganese, zinc, copper, and molybdenum. Particularly, manganese is preferable.

To support a transition metal oxide on the co-continuous body, a conventional known method can be used. For example, there is a method by which, after impregnated with an aqueous solution of a transition metal chloride or a transition metal nitrate, a co-continuous body evaporates to dryness, and is then subjected to hydrothermal synthesis in water (H₂O) under high temperature and pressure. Also, there is a precipitation method by which a co-continuous body is impregnated with an aqueous solution of a transition metal chloride or a transition metal nitrate, and an alkaline aqueous solution is added dropwise thereto. Further, there is a sol-gel method by which a co-continuous body is impregnated with a transition metal alkoxide solution, and is hydrolyzed. The conditions for each of these methods according to liquid phase methods are known, and these known conditions can be applied. In this embodiment, a liquid phase method is preferable.

In many cases, a metal oxide supported by the above liquid phase methods is in an amorphous state, because crystallization thereof has not progressed. The precursor in an amorphous state is subjected to a heat treatment in an inert atmosphere at a high temperature of about 500° C., so that a crystalline metal oxide can be obtained. Such a crystalline metal oxide exhibits high performance even in a case where it is used as the catalyst for the air electrode.

On the other hand, the precursor powder obtained in a case where the amorphous precursor described above is dried at a relatively low temperature of about 100 to 200° C. is in the form of a hydrate while maintaining an amorphous state. A hydrate of a metal oxide can be formally expressed as MeₓO_{y}·nH₂O (where Me means the above metal, x and y each represent the number of metal and oxygen molecules included the metal oxide molecules, and n represents the number of moles of H₂O with respect to 1 mol of the metal oxide). The hydrate of the metal oxide obtained through such low-temperature drying can be used as the catalyst.

Having been hardly sintered, the amorphous metal oxide (the hydrate) has a large surface area, and a very small particle size of about 30 nm. This is suitable as a catalyst, and the use of this catalyst will lead to excellent battery performance.

As described above, a crystalline metal oxide exhibits high activity, but the surface area of the metal oxide crystallized through a high-temperature heat treatment as described above might decrease significantly, and the particle size might become about 100 nm due to aggregation of particles. Note that this particle size (the average particle size) is the value obtained by enlarging and observing particles with a scanning electron microscope (SEM) or the like, measuring the diameter of the particles per 10 μm square (10 μm×10 μm), and calculating the average value.

Particularly, in the case of a catalyst formed with a metal oxide subjected to a heat treatment at a high temperature, the particles aggregate, and therefore, it might be difficult to add the catalyst to the surface of the co-continuous body with high dispersion. To achieve a sufficient catalytic effect, it is necessary to add a large amount of metal oxide to the air electrode (the co-continuous body) in some cases, and production of a catalyst through a heat treatment at a high temperature might be disadvantageous in terms of cost.

To solve this problem, Manufacturing Method 4, Manufacturing Method 5, or Manufacturing Method 6 described below should be used.

Manufacturing Method 4 Catalyst)

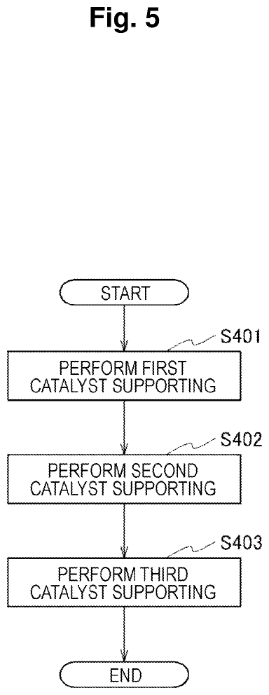

Next, Manufacturing Method 4 is described with reference to FIG. 5. FIG. 5 is a flowchart for explaining Manufacturing Methods 4, 5, and 6.

By Manufacturing Method 4, a catalyst is supported on a MPC-supporting co-continuous body manufactured by Manufacturing Method 1 or Manufacturing Method 2. Manufacturing Method 4 includes the catalyst supporting steps described below for supporting a catalyst, in addition to the co-continuous body manufacturing described above.

First, in the first catalyst supporting step in step S401, the co-continuous body is immersed in an aqueous solution of a surfactant, so that the surfactant is made to adhere to the surface of the co-continuous body.

Next, in the second catalyst supporting step in step S402, an aqueous solution of a metal salt is used, so that, because of the surfactant, the metal salt is made to adhere to the surface of the co-continuous body having the surfactant adhering thereto.

Next, in the third catalyst supporting step in step S403, a heat treatment is performed on the co-continuous body having the metal salt adhering thereto, so that the catalyst containing the metal forming the metal salt or an oxide of the metal is supported on the co-continuous body.

Note that the above metal is at least one metal selected from the group consisting of iron, manganese, zinc, copper, and molybdenum, or an oxide of at least one metal selected from the group consisting of calcium, iron, manganese, zinc, copper, and molybdenum. Particularly, manganese (Mn) or manganese oxide (MnO₂) is preferable.

The surfactant that is used in the first catalyst supporting step of Manufacturing Method 4 is for supporting a metal or a transition metal oxide with high dispersion on the air electrode (the co-continuous body). When a hydrophobic group that adsorbs onto a carbon surface and a hydrophilic group to which transition metal ions adsorb are contained in molecules as in a surfactant, metal ions as the transition metal oxide precursor can be made to adsorb to the co-continuous body with a high degree of dispersion.

The surfactant described above is not limited to any specific kind, as long as it contains a hydrophobic group that adsorbs to a carbon surface and a hydrophilic group to which manganese ions adsorb in the molecules. However, a non-ionic surfactant is preferable. Examples of ester surfactants include glyceryl laurate, glyceryl monostearate, sorbitan fatty acid ester, and sucrose fatty acid ester. Also, examples of ether surfactants include polyoxyethylene alkyl ether, polyoxyethylene alkylphenyl ether, and polyoxyethylene polyoxypropylene glycol.

Further, examples of ester ether surfactants include polyoxyethylene sorbitan fatty acid ester, polyoxyethylene hexitane fatty acid ester, and sorbitan fatty acid ester polyethylene glycol. Also, examples of alkanolamide surfactants include lauric acid diethanolamide, oleic acid diethanolamide, stearic acid diethanolamide, and cocamide DEA. Further, examples of higher alcohol surfactants include cetanol, stearyl alcohol, and oleyl alcohol. Also, examples of poloxamer surfactants include poloxamer dimethacrylate.

The concentration of the surfactant in the aqueous solution in the first catalyst supporting step of Manufacturing Method 4 is preferably 0.1 to 20 g/L. Also, the immersion conditions such as immersion time and immersion temperature include immersion in a solution at a temperature between room temperature and 50° C. for one to 48 hours, for example.

The second catalyst supporting step of Manufacturing Method 4 includes further dissolving a metal salt functioning as a catalyst or adding an aqueous solution of a metal salt to the aqueous solution containing the surfactant in the first catalyst supporting step. Alternatively, separately from the above aqueous solution containing the surfactant, an aqueous solution in which a metal salt functioning as a catalyst is dissolved may be prepared, and the co-continuous body impregnated with the surfactant (or having the surfactant adhering thereto) may be immersed in the aqueous solution.

Also, the co-continuous body to which the surfactant adheres may be impregnated with the aqueous solution in which the metal salt is dissolved. If necessary, an alkaline aqueous solution may be added dropwise to the resultant co-continuous body containing the metal salt (or having the metal salt adhering thereto). As a result, the metal or the metal oxide precursor can be made to adhere to the co-continuous body.

The amount of addition of the metal salt in the second catalyst supporting step of Manufacturing Method 4 is preferably 0.1 to 100 mmol/L. Also, the immersion conditions such as immersion time and immersion temperature include immersion in a solution at a temperature between room temperature and 50° C. for one to 48 hours, for example.

More specifically, taking manganese as an example of the metal, a manganese metal salt (a manganese halide such as a manganese chloride, or a hydrate thereof, for example) is added to the aqueous solution that contains the surfactant and with which the co-continuous body is impregnated. An alkaline aqueous solution is then added dropwise to the obtained co-continuous body containing the manganese metal salt, so that a manganese hydroxide as the metal or the metal oxide precursor can be supported on the co-continuous body.

The amount of the supported catalyst formed with the manganese oxide described above can be adjusted with the concentration of the metal salt (a manganese chloride, for example) in the metal salt aqueous solution.

Further, examples of the alkali to be used in the alkaline aqueous solution include hydroxides of an alkali metal or an alkaline earth metal, ammonia water, ammonium aqueous solutions, and tetramethylammonium hydroxide (TMAH) aqueous solutions. The concentration of these alkaline aqueous solutions is preferably 0.1 to 10 mol/L.

In the third catalyst supporting step in Manufacturing Method 4, the metal or metal oxide precursor (the metal salt) adhering to the surface of the co-continuous body is converted into the metal or the metal oxide through a heat treatment.

Specifically, the co-continuous body to which the precursor adheres may be dried at a temperature between room temperature (about 25° C.) and 150° C., or more preferably at 50° C. to 100° C., for one to 24 hours, and is then subjected to a heat treatment at 100 to 600° C., or preferably at 110 to 300° C.

In the third catalyst supporting step in Manufacturing Method 4, a heat treatment is performed in an inert atmosphere of argon, helium, nitrogen, or the like, or in a reducing atmosphere, so that an air electrode formed with a co-continuous body having a metal adhering as the catalyst to its surface can be manufactured. Alternatively, a heat treatment is performed in an oxygen-containing gas (an oxidizing atmosphere), so that an air electrode formed with a co-continuous body having a metal oxide adhering as the catalyst to its surface can be manufactured.

Further, it is also possible to manufacture an air electrode formed with a co-continuous body having a metal oxide adhering as the catalyst thereto, by performing a heat treatment under the above-described reductive conditions to once prepare a co-continuous body to which a metal adheres as the catalyst, and then subjecting the co-continuous body to a heat treatment in an oxidizing atmosphere.

By another method, a co-continuous body to which a metal or metal oxide precursor (a metal salt) adheres may be dried at a temperature between room temperature and 150° C., or more preferably at 50° C. to 100° C., and the metal may adhere as the catalyst onto the co-continuous body, to prepare a metal/co-continuous body composite.

In Manufacturing Method 4, the amount of adhesion (content) of the catalyst formed with a metal or a metal oxide is 0.1 to 70 wt %, or preferably 1 to 30 wt %, on the basis of the total weight of the co-continuous body and the catalyst.

By Manufacturing Method 4, it is possible to manufacture an air electrode in which a catalyst formed with a metal or a metal oxide is dispersed at a high concentration on the surface of a co-continuous body, and thus, it is possible to form a metal-air battery having excellent battery characteristics.

Manufacturing Method 5 (Catalyst)

Next, Manufacturing Method 5 is described with reference to FIG. 5. According to Manufacturing Method 5, a catalyst is supported on a co-continuous body manufactured by Manufacturing Method 1 or Manufacturing Method 2, by a different method from Manufacturing Method 4 described above. Manufacturing Method 5 includes the catalyst supporting steps described below for supporting a catalyst, in addition to the co-continuous body manufacturing described above.

First, in the first catalyst supporting step in step S401, a co-continuous body is immersed in an aqueous solution of a metal salt, so that the metal salt adheres to the surface of the co-continuous body.

Next, in the second catalyst supporting step in step S402, a heat treatment is performed on the co-continuous body having the metal salt adhering thereto, so that the catalyst containing the metal forming the metal salt is supported on the co-continuous body.

Next, in the third catalyst supporting step, the co-continuous body on which the catalyst is supported is caused to act on high-temperature and high-pressure water, to turn the catalyst into a hydrate of a metal oxide.

Note that the above metal is at least one metal selected from the group consisting of iron, manganese, zinc, copper, and molybdenum, or an oxide of at least one metal selected from the group consisting of calcium, iron, manganese, zinc, copper, and molybdenum. Particularly, manganese or manganese oxide (MnO₂) is preferable. In the first catalyst supporting step in Manufacturing Method 5, an aqueous solution of the metal salt to be the metal or metal oxide precursor that will be the catalyst in the end is made to adhere to (supported by) the surface of the co-continuous body. For example, an aqueous solution in which the metal salt is dissolved is separately prepared, and the co-continuous body is impregnated with the aqueous solution. The impregnation conditions and the like are the same as those in conventional cases as described above.

The second catalyst supporting step in Manufacturing Method 5 is the same as the third catalyst supporting step of Manufacturing Method 4, and a heat treatment in an inert atmosphere or a reducing atmosphere is performed. Alternatively, by the method described as another method in the third catalyst supporting step of Manufacturing Method 4, the co-continuous body to which the precursor adheres may be subjected to a heat treatment (dried) at a low temperature (room temperature to 150° C., or more preferably 50° C. to 100° C.), to cause the metal to adhere to the co-continuous body.

The air electrode 101 using a metal as the catalyst exhibits a high activity. However, since the catalyst is a metal, the air electrode 101 is weak against corrosion, and lacks long-term stability in some cases. On the other hand, the metal is subjected to a heat treatment to form a hydrate of a metal oxide in the third catalyst supporting step of Manufacturing Method 5 described below in detail, and thus, long-term stability can be achieved.

Next, in the third catalyst supporting step of Manufacturing Method 5 in step S403, a hydrate of a metal oxide adheres to the co-continuous body. Specifically, the co-continuous body having the metal adhering thereto as obtained in the second catalyst supporting step of Manufacturing Method 5 is immersed in high-temperature and high-pressure water, and the adhering metal is converted into a catalyst formed with a hydrate of a metal oxide.

For example, the co-continuous body having the metal adhering thereto may be immersed in water at 100° C. to 250° C., or more preferably at 150° C. to 200° C., and the adhering metal is oxidized and is turned into a hydrate of a metal oxide.

Since the boiling point of water at atmospheric pressure (0.1 MPa) is 100° C., the co-continuous body cannot be immersed in water at 100° C. or higher at atmospheric pressure normally. However, with the use of a predetermined sealed container, the pressure in the sealed container is increased to 10 to 50 MPa, or preferably to about 25 MPa, for example, so that the boiling point of water can be increased in the sealed container, and liquid water at 100° C. to 250° C. can be obtained. As the co-continuous body having a metal adhering thereto is immersed in the high-temperature water obtained in this manner, the metal can be turned into a hydrate of a metal oxide.

Manufacturing Method 6 (Catalyst)

Next, Manufacturing Method 6 is described. According to Manufacturing Method 6, a catalyst is supported on a co-continuous body manufactured by Manufacturing Method 1 or Manufacturing Method 2, by a different method from Manufacturing Methods 4 and 5 described above. Manufacturing Method 6 includes the catalyst supporting steps described below for supporting a catalyst, in addition to the co-continuous body manufacturing described above. Note that Manufacturing Method 6 ends after the second catalyst supporting step, and does not include the third catalyst supporting step.

First, in the first catalyst supporting step in step S401, a co-continuous body is immersed in an aqueous solution of a metal salt, so that the metal salt adheres to the surface of the co-continuous body.

Next, in the second catalyst supporting step in step S402, the co-continuous body having the metal salt adhering thereto is made to act on high-temperature and high-pressure water, so that the catalyst formed with a hydrate of a metal oxide of the metal forming the metal salt is supported on the co-continuous body.

Note that the metal is only required to be at least one metal selected from the group consisting of iron, manganese, zinc, copper, and molybdenum.

The first catalyst supporting step in Manufacturing Method 6 is the same as the first catalyst supporting step in Manufacturing Method 5, and therefore, explanation thereof is not made herein.

In the second catalyst supporting step in Manufacturing Method 6, the precursor (the metal salt) adhering to the surface of the co-continuous body is converted into a hydrate of a metal oxide through a heat treatment at a relatively low temperature.

Specifically, the co-continuous body to which the precursor adheres is made to act on high-temperature and high-pressure water, and is then dried at a relatively low temperature of about 100 to 200° C. As a result, the precursor turns into a hydrate in which water molecules are present among the particles, while the amorphous state of the precursor is maintained. The hydrate of the metal oxide obtained through such low-temperature drying is used as the catalyst.

In the air electrode manufactured by Manufacturing Method 6, the hydrate of the metal oxide can be supported with high dispersion in the form of nano-sized fine particles on the co-continuous body. Accordingly, in a case where such a co-continuous body is used as the air electrode, excellent battery performance can be exhibited.

A co-continuous body obtained by any of the above manufacturing methods can be formed into a predetermined shape by a known procedure, and be turned into an air electrode.

### Example 1 (Air Electrode: MPC-Supporting Co-Continuous Body)

Example 1 is an example in which the air electrode manufactured by the manufacturing method described in Manufacturing Method 1. For the air electrode, a co-continuous body having a three-dimensional network structure supporting MPC is used as the conductive material. The co-continuous body has a three-dimensional network structure that is formed with a plurality of nanofibers integrated by non-covalent bonding.

In the description below, a manufacturing method that uses carbon nanofibers for the co-continuous body and CMK-3 as MPC will be described as an example. However, it is possible to adjust the co-continuous body having a three-dimensional network structure supporting MPC, by changing the carbon nanofibers and the CMK-3 to some other materials.

Note that the degrees of porosity shown below were calculated by modeling fine pores as cylindrical shapes from a pore size distribution obtained by calculating a co-continuous body by a mercury intrusion technique.

Method for Manufacturing a Positive Electrode

First, commercially available SBA-15 (manufactured by Sigma-Aldrich Co. LLC) was put in a beaker, was impregnated with furfuryl alcohol, was dried in a draft for 3 hours, and was then heated at a temperature rising rate of 4° C./min for 6 hours in a nitrogen atmosphere to perform carbon coating. Hydrofluoric acid was added to this, to remove silica and obtain CMK-3.

Next, a commercially available carbon nanofiber sol (the dispersion medium: water (H₂O), 0.4 wt %, manufactured by Sigma-Aldrich Co. LLC) was put in a test tube, and the synthesized CMK-3 was further put therein, followed by stirring for 3 hours. After that, the test tube was immersed in liquid nitrogen for 30 minutes, to completely freeze the CMK-3 supporting carbon nanofiber sol. After the carbon nanofiber sol was completely frozen, the frozen carbon nanofiber sol was taken out and was put into an eggplant flask. The frozen carbon nanofiber sol was then dried in a vacuum of 10 Pa or lower with a freeze dryer (manufactured by Tokyo Rikakikai Co., Ltd.), to obtain a stretchable co-continuous body that has a three-dimensional network structure containing carbon nanofibers supporting CMK-3.

The obtained co-continuous body was evaluated through X-ray diffraction (XRD) measurement, scanning electron microscope (SEM) observation, porosity measurement, a tensile test, and BET specific surface area measurement. The co-continuous body prepared in this example was confirmed to be a carbon (C, PDF Card No. 00-058-1638) single phase by the XRD measurement. Note that the PDF Card No. is a card number in Powder Diffraction File (PDF), which is a database constructed by the International Centre for Diffraction Data (ICDD), and the same applies in the description below.

Also, it was confirmed by the SEM observation and a mercury intrusion technique that the co-continuous body was a co-continuous body in which nanofibers were continuously present, with the average pore size being 0.7 μm. Further, the BET specific surface area of the co-continuous body was measured by the mercury intrusion technique, and was found to be 880 m²/g. Also, the degree of porosity of the co-continuous body was measured by the mercury intrusion technique, and was found to be 85% or higher. From the results of the tensile test, it was confirmed that the co-continuous body did not exceed the elastic region, and restored to the shape the co-continuous body had before the stress application, even when a strain of 40% was applied to the co-continuous body by a tensile stress.

Battery Manufacturing Method, and Discharge Test Method

Such a co-continuous body formed with carbon nanofibers was cut into a circle having a diameter of 14 mm with a punching blade, a laser cutter, or the like, to obtain a gas-diffusion air electrode.

The negative electrode was prepared by cutting out a commercially available metallic zinc plate (thickness: 300 μm, manufactured by The Nilaco Corporation) into a circle having a diameter of 14 mm with a punching blade, a laser cutter, or the like.

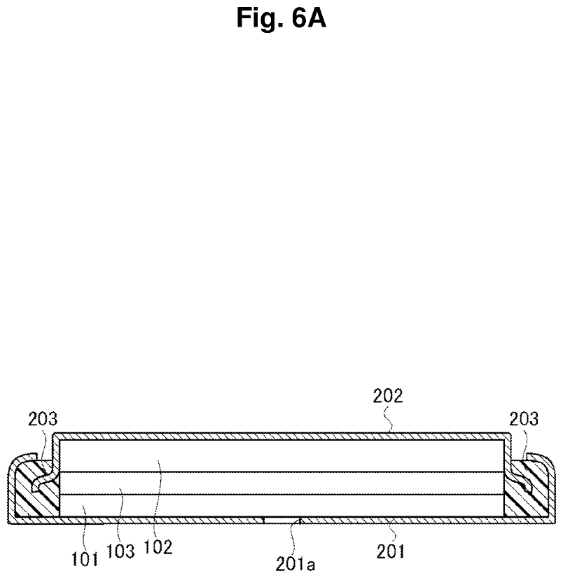

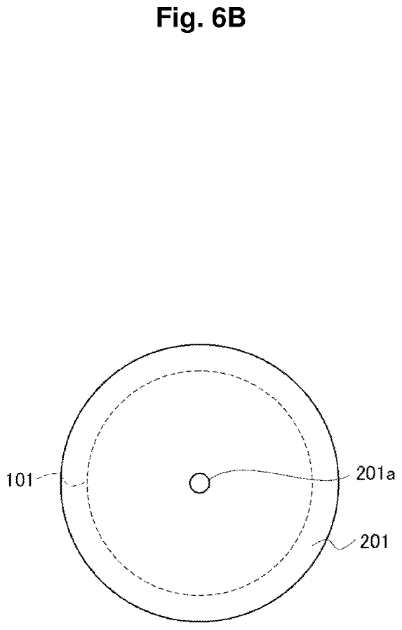

The electrolytic solution was a solution in which a potassium chloride (KCl, manufactured by Kanto Chemical Co., Inc.) was dissolved in pure water at a concentration of 1 mol/L. The separator was a cellulose-based separator for batteries (manufactured by Nippon Kodoshi Corporation). The air electrode, the negative electrode, the electrolytic solution to be the electrolyte, and the separator described above were used to produce a coin-cell zinc-air battery illustrated in FIGS. 6A and 6B.

FIG. 6A is a cross-sectional view of a coin-cell zinc-air battery according to this example. FIG. 6B is a bottom view of the coin-cell zinc-air battery according to this example, as viewed from the air electrode side. First, the air electrode 101 was placed on an air electrode case 201 in which the edge portion of a copper mesh foil (manufactured by MIT Japan) was fixed to the inside by spot welding. The air electrode case 201 has an air hole 201a. Also, as for the negative electrode 102 formed with a metallic zinc plate, the edge portion was fixed to a copper mesh foil (manufactured by MIT Japan) by spot welding, and the copper mesh foil was fixed to a negative electrode case 202 by spot welding.

Next, a separator was placed on the air electrode 101 installed in the air electrode case 201, and an electrolytic solution was injected into the separator, to obtain the electrolyte 103. Next, the air electrode case 201 was covered with the negative electrode case 202 to which the negative electrode 102 was fixed, and the edge portions of the air electrode case 201 and the negative electrode case 202 were swaged with a coin-cell swaging tool, to prepare a coin-cell zinc-air battery including a polypropylene gasket 203.

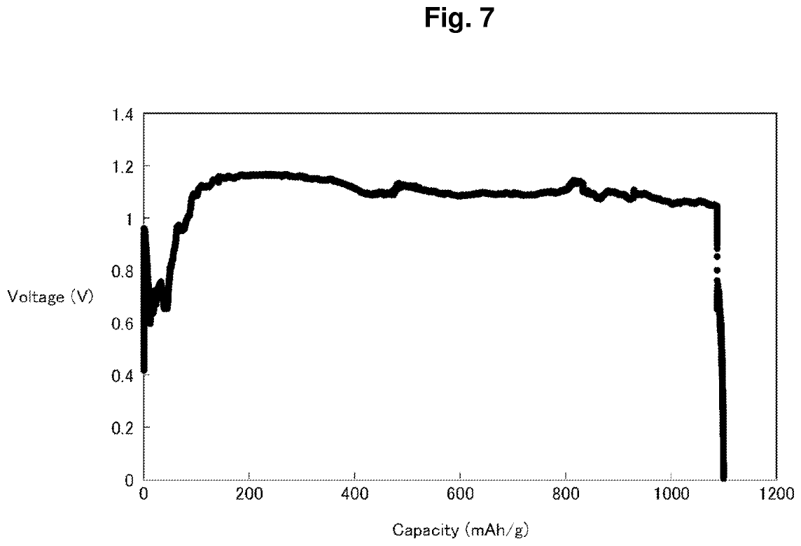

The battery performance of the prepared coin-cell zinc-air batteries was measured. First, a discharge test was conducted. In the discharge test on the zinc-air battery, a commercially available charge/discharge measurement system (SD8 Charge/Discharge System, manufactured by Hokuto Denko Corporation) was used, and 0.1 mA/cm 2 was applied at a current density per effective area of the air electrode. Measurement was then performed until the discharge voltage dropped from the open circuit voltage to 0 V. In the discharge test on the zinc-air battery, measurement was carried out in a thermostatic chamber at 25° C. (atmosphere: an ordinary living environment). A discharge capacity was represented by a value (mAh/g) per weight of the air electrode including the co-continuous body. FIG. 7 shows a discharge curve in the zinc-air battery of this example.

As can be seen from FIG. 7, the average discharge voltage in a case where a co-continuous body was used for the air electrode is 1.1 V, and the discharge capacity is 1100 mAh/g. Note that the average discharge voltage is the battery voltage at a discharge capacity (550 mAh/g in Example 1), which is ½ of the discharge capacity (1100 mAh/g in this example) of the battery.

The values of the average discharge voltage and the discharge capacity were greater than those of Comparative Example 1 in which an air electrode using powdered carbon was evaluated as described later. It is considered that, since the co-continuous body supporting MPC has a higher specific surface area than that of powdered carbon, the oxygen reduction reaction is facilitated, and a discharge product (Zn(OH)₂) can be efficiently precipitated, leading to an improved average discharge voltage and an improved discharge capacity. The MPC-supporting co-continuous body manufactured by Manufacturing Method 2 described above can also be evaluated in the same manner as in this Example.

### Example 2 (Air Electrode: MPC-Supporting Co-Continuous Body Supporting the Catalyst)

In Example 2, a positive electrode in which an oxide or a metal is supported as the catalyst on a MPC-supporting co-continuous body material is described. In the description below, a case where MnO₂ is supported as the catalyst on a co-continuous body is described as an example. However, Mn may be changed to any appropriate metal so that an appropriate oxide can be supported as the catalyst on the co-continuous body. Alternatively, any neutralizing step may not be carried out so that an appropriate metal can be supported at the catalyst on the co-continuous body.

The co-continuous body was prepared and evaluated, a zinc-air battery was manufactured, and a discharge test was conducted in the same manners as those in Example 1.

In Example 2, a commercially available manganese (II) chloride tetrahydrate (MnCl₂·4H₂O; Kanto Chemical Co., Inc.) was dissolved in distilled water and was impregnated with the co-continuous body prepared in Example 1, and the manganese chloride was supported on the co-continuous body. Ammonia water (28%) was then gradually added dropwise to the co-continuous body supporting the manganese chloride (the manganese chloride supported by the co-continuous body) until pH reached 7.0, and the mixture was neutralized to precipitate a manganese hydroxide. The precipitate was repeatedly washed with distilled water five times so that chlorine would not remain. The obtained co-continuous body supporting the manganese hydroxide was subjected to a heat treatment at 500° C. for six hours in an argon atmosphere, to produce a co-continuous body supporting a manganese oxide (MnO₂).

The produced co-continuous body supporting the manganese oxide was subjected to XRD measurement and TEM observation, and was evaluated. Through the XRD measurement, the peak of the manganese oxide (MnO₂, PDF file No. 00-011-079) was observed. It was confirmed that the catalyst supported on the co-continuous body was a manganese oxide single phase. Also, it was observed with a TEM that the manganese oxide was precipitated in the form of particles having an average particle size of 100 nm on the surface of the co-continuous body.

This co-continuous body supporting the manganese oxide was used as the positive electrode in manufacturing a zinc-air battery. Table 1 shows the result of this example, as well as the results in cases where other catalysts were used.

TABLE 1

| Catalyst/co-continuous | |
|---|---|
| body material | Discharge voltage (V) |
| MnO₂/C | 1.20 |
| Fe₂O₃/C | 1.17 |
| ZnO₂/C | 1.12 |
| MoO₃/C | 1.11 |
| Fe/C | 1.18 |
| Mn/C | 1.17 |
| Zn/C | 1.13 |
| Mo/C | 1.11 |
| Example 1 (C) | 1.10 |

In a metal-air battery using the manganese-oxide-supporting co-continuous body of Example 2, the discharge capacity was 1250 mAh/g, and the average discharge voltage was 1.20 V, which were higher than those in a case where the co-continuous body of Example 1 not supporting any catalyst was used. It is considered that not only the stretchability of the positive electrode but also the supporting of the catalyst on the positive electrode lowered the reaction resistance at the positive electrode, and improved the discharge voltage.

### Comparative Example 1 (Air Electrode: Powdered Carbon)

Next, Comparative Example 1 is described. In the comparative example, a coin-cell zinc-air battery was manufactured in the same manner as in Example 1, using an air electrode different from that in Example 1. As the electrolyte, the same potassium chloride (1 mol/L) as that in Example 1 was used.

In Comparative Example 1, carbon (Ketjen Black EC600JD) known as an electrode for an air electrode, and manganese oxide were used for the air electrode in manufacturing a zinc-air battery, and the zinc-air battery was evaluated.

Manganese oxide powder (manufactured by Kanto Chemical Co., Inc.), Ketjen black powder (manufactured by Lion Corporation), and polytetrafluoroethylene (PTFE) powder (manufactured by Daikin Industries, Ltd.) were sufficiently pulverized and mixed at a weight ratio of 50:30:20 with a mortar machine, and were subjected to roll molding, to form a sheet-like electrode (thickness: 0.5 mm). This sheet-like electrode was cut out into a circle having a diameter of 14 mm, and thus, the air electrode was obtained. The conditions for the battery discharge test are the same as those in Example 1.

Table 2 shows the average discharge voltage of the zinc-air battery according to Comparative Example 1, as well as the results of Examples 1 and 2.

TABLE 2

| | Discharge capacity | Average discharge |
|---|---|---|
| Air electrode | (mAh/g) | voltage (V) |
| [Example 1] MPC- | 1100 | 1.10 |
| supporting co- | | |
| continuous body | | |
| [Example 2] MPC- | 1250 | 1.20 |
| supporting co- | | |
| continuous body + | | |
| catalyst | | |
| [Comparative Example | 680 | 0.83 |
| 1] Powered carbon | | |
| [Comparative Example | 850 | 1.02 |
| 2] Co-continuous body | | |

As shown in Table 2, the discharge capacity of Comparative Example 1 was 680 mAh/g, and the average discharge voltage was 0.83 V, which were lower than those of Example 1. Also, when the air electrode of Comparative Example 1 was observed after the measurement, it was seen that part of the air electrode collapsed and was dispersed in the electrolytic solution, and the electrode structure of the air electrode was destroyed. From the above results, it was confirmed that a metal-air battery of this embodiment is superior in capacity and voltage to a metal-air battery using an air electrode formed with a known material.

### Comparative Example 2 (Air Electrode: A Co-Continuous Body)

Next, Comparative Example 2 is described. In Comparative Example 2, the carbon nanofibers of Example 1 were used, and a co-continuous body prepared without mixing MPC in the gel producing step was used for the air electrode. That is, a co-continuous body not supporting MPC was used for an air electrode of Comparative Example 2.

The obtained co-continuous body was evaluated through XRD measurement, SEM observation, porosity measurement, a tensile test, and BET specific surface area measurement. The co-continuous body prepared in this comparative example was confirmed to be a carbon (C, PDF Card No. 00-058-1638) single phase by the XRD measurement. Also, it was confirmed by the SEM observation and a mercury intrusion technique that the obtained co-continuous body was a co-continuous body in which nanofibers were continuously present, with the average pore size being 1 μm. Further, the BET specific surface area of the co-continuous body was measured by the mercury intrusion technique, and was found to be 620 m²/g. Also, the degree of porosity of the co-continuous body was measured by the mercury intrusion technique, and was found to be 93% or higher. Furthermore, from the results of the tensile test, it was confirmed that the co-continuous body of this comparative example did not exceed the elastic region, and restored to the shape the co-continuous body had before the stress application, even when a strain of 40% was applied to the co-continuous body by a tensile stress.

As shown in Table 2, in the zinc-air battery of Comparative Example 2, the discharge capacity was 850 mAh/g, and the average discharge voltage was 1.02 V, which were higher than those of Comparative Example 1 in which powdered carbon was used for the air electrode, but were lower than those of Example 1 in which a co-continuous body supporting MPC was used for the air electrode.

This is supposedly because the air electrode of Comparative Example 2, which had a higher stretchability than the air electrode of Comparative Example 1, efficiently precipitated the discharge product [Zn(OH)²], and thus, the discharge capacity was improved. Further, in Comparative Example 2, since MPC is not supported, the specific surface area was smaller than that in Example 1. Therefore, the resistance to positive electrode reactions became higher, and the average discharge voltage became lower.

From these results, it was confirmed that a metal-air battery of this embodiment is superior in voltage and capacity to a metal-air battery using a positive electrode formed with a known material. Also, since a reaction of the positive electrode in an aqueous metal-air battery has a similar reaction mechanism, even in a case where the negative electrode is changed from zinc to some other metal, improvement in battery performance can be expected from the improvement in efficiency of positive electrode reactions.

As described above, a metal-air battery of this embodiment includes an air electrode, a negative electrode containing a metal, and an electrolyte having ion conductivity. The air electrode includes: a co-continuous body having a three-dimensional network structure in which a plurality of nanostructures is split and integrated; and mesoporous carbon supported on the co-continuous body.

Further, a method for manufacturing an air electrode according to this embodiment includes: a synthesizing step of synthesizing mesoporous carbon, using mesoporous silica as a precursor; a producing step of producing a sol or gel in which the mesoporous carbon and a plurality of nanostructures are dispersed; a freezing step of freezing the sol or gel, to obtain a frozen material; a drying step of drying the frozen material in vacuum, to obtain a co-continuous body having a three-dimensional network structure, the mesoporous carbon being supported on the co-continuous body, the plurality of nanostructures being split and integrated in the co-continuous body; and a carbonizing step of carbonizing the co-continuous body by heating the co-continuous body in a gas atmosphere in which cellulose does not burn.

Further, a method for manufacturing an air electrode according to this embodiment includes: a precursor synthesizing step of causing mesoporous silica as a template to react with an organic compound, to obtain a precursor of mesoporous carbon; a producing step of producing a sol or gel in which the precursor and a plurality of nanostructures are dispersed; a freezing step of freezing the sol or gel, to obtain a frozen material; a drying step of drying the frozen material in vacuum, to obtain a co-continuous body having a three-dimensional network structure, the precursor being supported on the co-continuous body, the plurality of nanostructures being split and integrated in the co-continuous body; a carbonizing step of heating the co-continuous body in a gas atmosphere in which cellulose does not burn, to carbonize the co-continuous body; and a synthesizing step of performing etching on the carbonized co-continuous body, to remove the mesoporous silica of the precursor, and synthesizing the mesoporous carbon.

As described above, in this embodiment, an air electrode that has MPC supported on a co-continuous body having a three-dimensional network structure in which a plurality of nanostructures is integrated by non-covalent bonding is used, so that a higher-performance metal-air battery can be obtained.

Furthermore, a metal-air battery of this embodiment contains neither elements that are used for soil fertilizers nor metal elements other than the metals contained in rainwater or seawater, and spontaneously decomposes. Thus, the metal-air battery exhibits an extremely low environmental burden. Such batteries can be effectively used as various drive sources such as disposable batteries in daily environments and sensors to be used in soil. Also, according to this embodiment, the discharge capacity and the discharge voltage of a metal-air battery can be made higher.

Note that the present invention is not limited to the embodiment described above, and it is obvious that many modifications and combinations can be implemented by a person having ordinary knowledge in the art within the technical idea of the present invention.

### REFERENCE SIGNS LIST

101 air electrode
102 negative electrode
103 electrolyte

1. A metal-air battery comprising:
an air electrode;
a negative electrode containing a metal; and
an electrolyte having ion conductivity,
wherein the air electrode includes: a co-continuous body having a three-dimensional network structure in which a plurality of nanostructures is split and integrated; and mesoporous carbon supported on the co-continuous body.

2. The metal-air battery according to claim 1, wherein
the air electrode includes a catalyst, and
the catalyst contains at least one metal selected from the group consisting of iron, manganese, zinc, copper, and molybdenum, or an oxide of at least one metal selected from the group consisting of calcium, iron, manganese, zinc, copper, and molybdenum.

3. A method for manufacturing an air electrode of a metal-air battery, the method comprising:
a synthesizing step of synthesizing mesoporous carbon;
a producing step of producing a sol or gel in which the mesoporous carbon and a plurality of nanostructures are dispersed;
a freezing step of freezing the sol or gel, to obtain a frozen material; and
a drying step of drying the frozen material in vacuum, to obtain a co-continuous body having a three-dimensional network structure, the mesoporous carbon being supported on the co-continuous body, the plurality of nanostructures being split and integrated in the co-continuous body.

4. A method for manufacturing an air electrode of a metal-air battery, the method comprising:
a precursor synthesizing step of causing mesoporous silica as a template to react with an organic compound, to obtain a precursor of mesoporous carbon;
a producing step of producing a sol or gel in which the precursor and a plurality of nanostructures are dispersed;
a freezing step of freezing the sol or gel, to obtain a frozen material;
a drying step of drying the frozen material in vacuum, to obtain a co-continuous body having a three-dimensional network structure, the precursor being supported on the co-continuous body, the plurality of nanostructures being split and integrated in the co-continuous body;
a carbonizing step of heating the co-continuous body in an inert gas atmosphere, to carbonize the precursor supported on the co-continuous body; and
a synthesizing step of performing etching on the carbonized precursor, to remove the mesoporous silica of the precursor, and synthesizing the mesoporous carbon.

5. The method for manufacturing an air electrode according to claim 3, further comprising
a catalyst supporting step of supporting a catalyst on the co-continuous body.

6. The method for manufacturing an air electrode according to claim 4, further comprising
a catalyst supporting step of supporting a catalyst on the co-continuous body.
